(19) United States
(12) Patent Application Publication
(10) Pub. No.: US 2025/0351071 A1
(43) Pub. Date: Nov. 13, 2025

(54) WIRELESS COMMUNICATION METHOD AND USER DEVICE

(71) Applicant: MEDIATEK INC., Hsinchu City (TW)

(72) Inventors: Wai Seng NG, Hsinchu City (TW); Tien-Jen LIU, Hsinchu City (TW); Kai-Wei OU, Hsinchu City (TW)

(21) Appl. No.: 19/194,385

(22) Filed: Apr. 30, 2025

Related U.S. Application Data
(60) Provisional application No. 63/645,217, filed on May 10, 2024.

(51) Int. Cl. H04W 52/02; H04W 76/28

(52) U.S. Cl. CPC H04W 52/0216; H04W 52/0235; H04W 52/0238; H04W 76/28

(57) ABSTRACT

User equipment (UE) is provided. The UE comprises a processing circuit and a modem. The processing circuit is configured to execute an application. The processing circuit is further configured to determine whether a first condition, a second condition, and a third condition are satisfied; and control the UE to switch to a low-power mode, in response to a determination that the first condition, the second condition, and the third condition are satisfied. The application transmits data to the modem of the UE at the beginning of a connected mode discontinuous reception (cDRX)-on cycle in the low-power mode. The modem is configured to transmit the data transmitted from the application to the modem to a base station on the PUSCH.

### CROSS REFERENCE TO RELATED APPLICATIONS

This application claims priority of U.S. Provisional Application Ser. No. 63/645,217, filed on 2024 May 10, the entirety of which is incorporated by reference herein.

### BACKGROUND OF THE INVENTION

### Field of the Invention

The present invention relates to wireless communication, and, in particular, it relates to apparatuses and methods for switching between different data transmission schemes.

### Description of the Related Art

Accompanying the rapid development of electronic products and fast changes in communication technology, the requirements for latency and power consumption have become more and more stringent. The user will expect low latency and low power consumption, especially when using a latency-sensitive application. In a typical mobile communication environment, a piece of User Equipment (UE) with wireless communications capability may communicate data with one or more mobile communication networks. The UE transmits data to the network through the uplink channel and receives data from the network through the downlink channel. For uplink communication, when the data arrives at the modulator-demodulator (modem) of the UE has a significant impact on latency and power consumption. Different points in time at which the data arrives at the modem can lead to variations in latency and power consumption.

Therefore, for a better user experience, the method for controlling and determining the point in time at which the data arrives at the modem is required.

### BRIEF SUMMARY OF THE INVENTION

An embodiment of the present invention provides a wireless communication method. The method comprises the operation of executing an application via user equipment (UE). The method further comprises the operation of determining whether a first condition, a second condition, and a third condition are satisfied via the UE. The method further comprises the operation of switching to a low-power mode via the UE, in response to a determination that the first condition, the second condition, and the third condition are satisfied. The application transmits data to a modulator-demodulator (modem) of the UE at the beginning of a connected mode discontinuous reception (cDRX)-on cycle in the low-power mode. The method further comprises the operation of transmitting the data transmitted from the application to the modem to a base station on a physical uplink shared channel (PUSCH) via the UE. The first condition is that a cDRX cycle of the UE is a predefined value. The second condition is that the reference signal received power (RSRP) measured at the UE is higher than the RSRP threshold and the signal-to-noise ratio (SNR) measured at the UE is higher than the SNR threshold. The third condition is that a fourth condition, a fifth condition, and a sixth condition are satisfied. The fourth condition is that all data transmitted from the application to the modem has been transmitted to the base station in a previous cDRX cycle. The fifth condition is that data transmitted from the UE to the base station on the PUSCH doesn't need to be retransmitted. The sixth condition is that no scheduling request (SR) transmitted from the UE to the base station has failed.

An embodiment of the present invention provides user equipment comprising a processing circuit and a modulator-demodulator (modem). The processing circuit is configured to execute an application. The processing circuit is further configured to determine whether a first condition, a second condition, and a third condition are satisfied; and control the UE to switch to a low-power mode, in response to a determination that the first condition, the second condition, and the third condition are satisfied. The application transmits data to the modem of the UE at the beginning of a connected mode discontinuous reception (cDRX)-on cycle in the low-power mode. The modem is configured to transmit the data transmitted from the application to the modem to a base station on a physical uplink shared channel (PUSCH). The first condition is that a cDRX cycle of the UE is a predefined value. The second condition is that the reference signal received power (RSRP) measured at the UE is higher than the RSRP threshold and the signal-to-noise ratio (SNR) measured at the UE is higher than the SNR threshold. The third condition is that a fourth condition, a fifth condition, and a sixth condition are satisfied. The fourth condition is that all data transmitted from the application to the modem has been transmitted to the base station in a previous cDRX cycle. The fifth condition is that data transmitted from the UE to the base station on the PUSCH doesn't need to be retransmitted. The sixth condition is that no scheduling request (SR) transmitted from the UE to the base station has failed.

### BRIEF DESCRIPTION OF THE DRAWINGS

The present invention can be more fully understood by reading the subsequent detailed description and examples with references made to the accompanying drawings, wherein:

FIG. 1 is a block diagram of the wireless communication system in accordance with the embodiments of the present disclosure;

FIGS. 2A and 2B illustrates the low-latency mode in accordance with the embodiments of the present disclosure;

FIG. 2C illustrates the low-power mode in accordance with the embodiments of the present disclosure;

FIG. 3A is the flow diagram of the wireless communication method in accordance with embodiments of the present disclosure;

FIG. 3B illustrates the finite state machine corresponding to the method shown in FIG. 3A;

FIGS. 4A and 4B illustrates the fourth condition and the sixth condition in accordance with embodiments of the present disclosure; and

FIG. 5 is a flow diagram of the wireless communication method in accordance with the embodiments of the present disclosure

### DETAILED DESCRIPTION OF THE INVENTION

The following description is made for the purpose of illustrating the general principles of the invention and should not be taken in a limiting sense. The scope of the invention is best determined by reference to the appended claims.

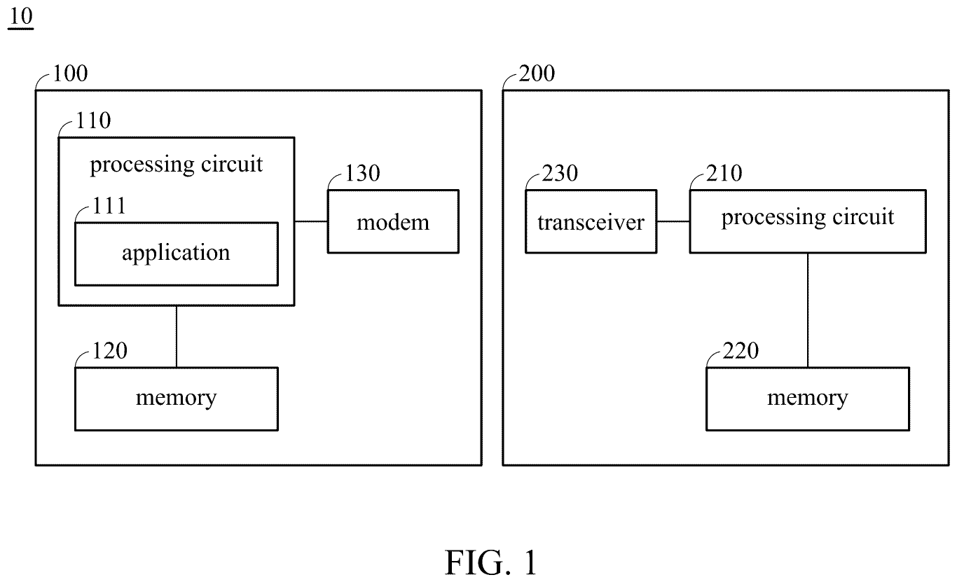

FIG. 1 is a block diagram of the wireless communication system 10 in accordance with the embodiments of the present disclosure. Wireless communication system 10 comprises user equipment (UE) 100 and a base station 200. The UE 100 wirelessly connects to base station 200. The UE 100 may connect to a network (such as an Internet) through the base station 200. For example, the UE 100 may be an electronic device, a mobile device, a wearable device, a wireless communication device, or a computing device. In some embodiments, UE 100 is implemented in a smartphone, a smartwatch, a tablet computer, or a notebook computer. The UE 100 comprises a processing circuit 110, a memory 120, and a modulator-demodulator (modem) 130.

The processing circuit 110 controls operations of the UE 100. The processing circuit 110 provides the required process ability to perform operating systems, programs, software, modules, applications, and functions of the UE 100. In some embodiments, processor 110 may be implemented in the form of hardware with electronic components including transistors, diodes, capacitors, resistors, or inductors. These components are configured and arranged to achieve specific purposes in accordance with the embodiments of the present disclosure. In other words, the processing circuit 110 is a special-purpose machine specifically configured to perform specific tasks including in accordance with the embodiments of the present disclosure. The processing circuit 110 may include at least one processor. For example, the processing circuit 110 may include a general purpose micro-processor, the special purpose processor, a central processing unit (CPU), an application processor, a graphics processing unit (GPU), an image signal processor (ISP), a controller, a digital signal processor (DSP), a neural-network processing unit (NPU), and/or related chip set. Different processors may be independent components, or may be integrated into one or more processors.

The memory 120 stores data and instructions required by the processing circuit 110. The memory 120 may include non-volatile memories, such as read only memory (ROM) and flash memory. The memory 120 may also include volatile memories, such as dynamic random access memory (DRAM) and static random access memory (SRAM). In some embodiments, the memory 120 stores a program, such as the computer-readable instruction. The program can be operated by the processing circuit 110. When the program is operated by the processing circuit 110, the program causes the processing circuit 110 to execute the application 111 and methods in accordance with the embodiments of the present disclosure.

The modem 130 is configured to wirelessly transmit data to the base station 200 and receive data from the base station 200. The modem 130 is configured to modulate the data received from the processing circuit 110 (or the application 111), convert the baseband signals to the radio frequency signals, and send out the RF signals carrying the data to the base station 200. The modem 130 is further configured to receive the RF signals from the base station 200, convert the RF signals to the baseband signals, demodulate the data carried in the signal received from the base station 200, and/or transmit the demodulated data to the processing circuit 110 or the application 111. In some embodiments, the modem 130 connects to one or more antenna.

Furthermore, the UE 100 may comprise other components which aren't shown in the FIG. 1, such as a SNR/RSRP measurement circuit for measuring the SNR/RSRP, a display or a touch screen, a battery, an internal power supply, an input-output device, and/or a microphone for receiving voice.

The base station 200 may be a router, a network node, an access point, an access terminal, an evolved Node-Bs (eNBs), or gNodeBs (gNBs). The base station 200 comprises a processing circuit 210 similar to the processing circuit 110, a memory 220 similar to the memory 120, and a transceiver 230. The transceiver 230 is capable to transmit and receive data wirelessly. The transceiver 230 may be coupled with one or more antennas.

In some embodiments, the processing circuit 110 is configured to execute (or perform) an application 111. The application 111 generates data and transmits the data to the modem 130. Then, the modem 130 transmits the data received from the application 111 to the base station 200. In other words, the data transmitted from the application 111 to the modem 130 is uplink data has to be transmitted to the base station 200. In some embodiments, the data transmitted from the application 111 to the modem 130 is voice data. For example, the application 111 may be a communication application which is able to make a phone call.

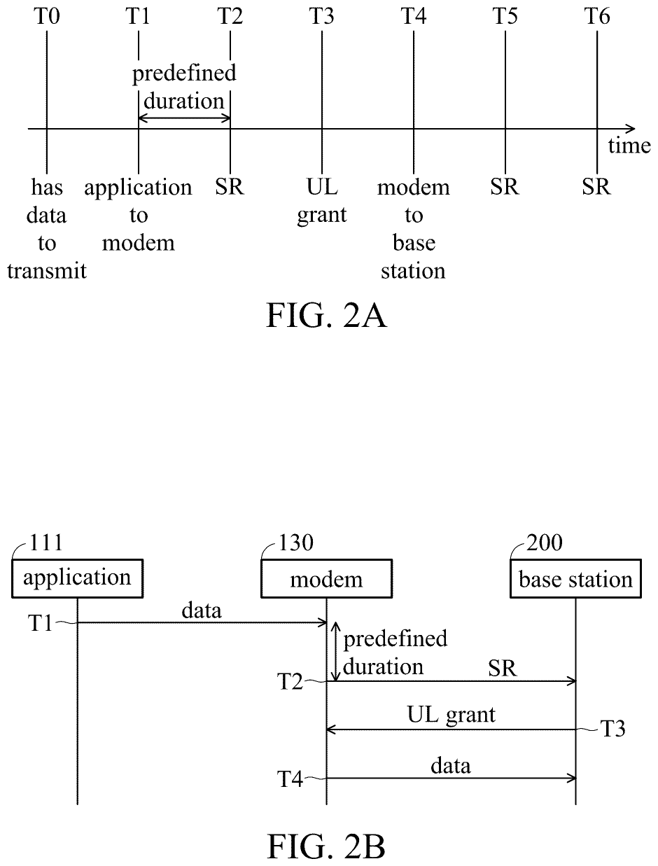

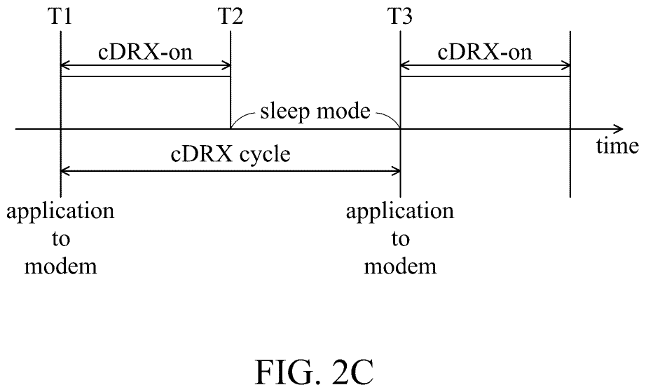

The point in time (or time point) at which the data transmitted from the application 111 arrives at the modem 130 can impact latency and power consumption. FIGS. 2A˜2C illustrates different data transmission schemes in accordance with the embodiments of the present disclosure. Refer to FIGS. 2A and 2B, FIGS. 2A and 2B illustrates the low-latency mode in accordance with the embodiments of the present disclosure. In the low-latency mode, the application 111 transmits data to the modem 130 at a first time point which is a predefined duration before a second time point that the UE 100 transmits a scheduling request (SR). For example, the predefined duration is 16 milliseconds (ms). As shown in FIG. FIGS. 2A and 2B, at time point T0, the application 111 generates data which has to be transmitted to the base station 200. At time point T1, the application 111 transmits data to the modem 130. At time point T2 which is the predefined duration after the time point T1, the UE 100 transmits an SR to the base station 200 through the modem 130. The SR indicates that the UE 100 requires to transmit data to the base station 200 on the physical uplink shared channel (PUSCH). At time point T3 after the time point T2, the UE 100 receives the uplink grant (UL grant) from the base station 200, in response to transmitting the SR. In response to receiving the UL grant, the UE 100 transmits the data (including the data transmitted from the application 111 to the modem 130 at time point T1) to the base station 200 through the modem 130.

Thus, in the low-latency mode, when the application 111 has data which has to be transmitted to the base station 200, the application 111 determines the earliest time point that the UE 100 will transmit the SR. Then, the application 111 transmits the data to the modem 130 at the time point which is the predefined duration before the earliest time point that the UE 100 will transmit the SR (i.e. time point T2). In other words, time point T2 is the time point which is nearest to the time point T0 and after the time point T0. For example, the UE 100 may determine to transmit SR at time point T5 and T6 after the time point T4. However, the application 111 will transmit the data generated at time point T0 to the modem 130 at the time point T1. Because at time point T0 the time point T2 is the earliest time point that the UE 100 will transmit the SR.

Refer to FIG. 2C, FIG. 2C illustrates the low-power mode in accordance with the embodiments of the present disclosure. In the low-power mode, the application 111 transmits data to the modem 130 at the beginning of a connected mode discontinuous reception (cDRX)-on cycle. At time point T1, the UE 100 wakes-up, and the application 111 transmits data (which has to be transmitted to the base station 200) to the modem 130. At time point T2, the UE 100 enters the sleep mode. The time duration between the time point T1 and time point T2 is the cDRX-on cycle (or cDRX on duration). Then, at the time point T3 after the time point T2, the UE 100 wakes-up from the sleep mode of the cDRX, and the application 111 may transmit data (which has to be transmitted to the base station 200) to the modem 130. The time duration between time point T1 and time point T3 is referred to the cDRX cycle. Thus, in the low-power mode, when the application 111 has data which has to be transmitted to the base station 200, the application 111 transmits the data to the modem 130 at the time point that the UE 100 wakes-up from the sleep mode of the cDRX. In the sleep mode of the cDRX, the UE 100 doesn't monitor and/or decode the physical downlink control channel (PDCCH). On the contrary, during the cDRX-on cycle, the UE 100 wakes-up and monitor and/or decode the PDCCH. In this disclosure, time point T1 and time point T3 may be referred to the beginning of the cDRX-on cycle.

In the low-latency mode, the UE 100 can request to transmit the data using the nearest SR, and the data can be transmitted to the base station 200 as soon as possible. Thus, the latency is reduced. The latency may refer to the time duration between time point T0 and time point T4. However, if the data arrives at the modem 130 while the modem 130 is in the sleep mode, the modem 130 has to wake-up, and extra power consumption is incurred. On the other hand, in the low-power mode, the data always arrives at the modem 130 during the cDRX-on cycle. Thus, no extra power consumption will be caused. However, in the low-power mode, the latency may increase, and there is a risk of packing multiple audio frames in one PUSCH. Thus, how to switch between these two modes is a problem need to be solved. Embodiments of the present disclosure provide a method for determining which mode should be applied.

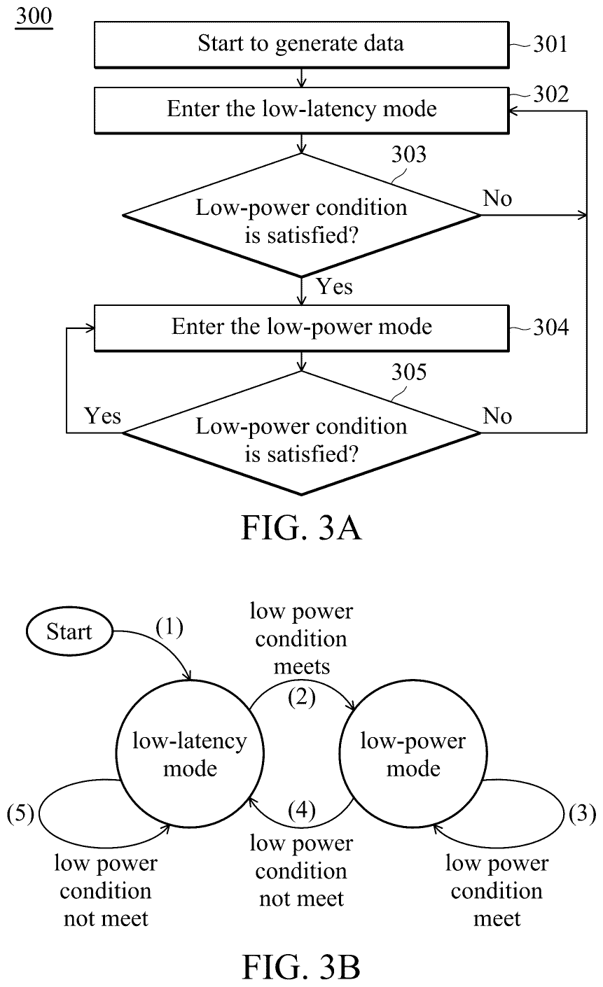

FIG. 3A is the flow diagram of the wireless communication method 300 in accordance with embodiments of the present disclosure. FIG. 3B illustrates the finite state machine corresponding to method 300. In operation 301, the application 111 starts to generate data (such as voice data), for example, in response to the voice call starts. Then, in operation 302, the processing circuit 110 controls the UE 100 to enter the low-latency mode (labeled as (1) in the FIG. 3B). In operation 303, the processing circuit 110 determines whether a low-power condition is satisfied. The low-power condition is detailed described below. When the low-power condition is satisfied, the UE 100 performs operation 304. In operation 304, the processing circuit 110 controls the UE 100 to enter the low-power mode (labeled as (2) in the FIG. 3B). In other words, the processing circuit 110 controls the UE 100 to switch from the low-latency mode to the low-power mode. When the low-power condition isn't satisfied, the UE 100 performs operation 302. In other words, the processing circuit 110 controls the UE 100 to stay in the low-latency mode (labeled as (5) in the FIG. 3B).

In some embodiments, in operation 303, the processing circuit 110 determines whether a low-power condition has been satisfied for (over) a predefined duration. The UE 100 switches to the low-power mode, in response to a determination that the low-power condition has been satisfied for a predefined duration. For example, the predefined duration is 1 second. In some embodiments, the processing circuit 110 may periodically determines whether the low-power condition has been satisfied for (over) the predefined duration at each determination occasions (time point). The time duration between the neighboring two determination occasions is the predefined duration (e.g. 1 second). If the low-power condition isn't satisfied at any time point, the processing circuit 110 waits to the next determination occasion and starts to determine whether the low-power condition has been satisfied for the predefined duration again. For example, the processing circuit 110 may determines whether the low-power condition is satisfied over 1 second at 1^{st}, 2^{nd}, 3^{rd}, 4^{th} . . . second. At 1.5^{th} second, the processing circuit 110 determines that the low-power condition isn't satisfied. Then, the processing circuit 110 waits until 2^{nd} second and determines whether the low-power condition is satisfied over 1 second at 2^{nd} second. If the low-power condition has been satisfied from 2^{nd} second to 3^{rd} second, the UE 100 switches to the low-power mode. Otherwise, the processing circuit 110 waits until 3^{rd} second and determines whether the low-power condition is satisfied over 1 second at 3^{rd} second.

In operation 305, the processing circuit 110 determines whether the low-power condition is satisfied. When the low-power condition is satisfied, the UE 100 performs operation 304 (labeled as (3) in the FIG. 3B). In other words, the processing circuit 110 controls the UE 100 to stay in the low-power mode. When the low-power condition isn't satisfied, the UE 100 performs operation 302 (labeled as (4) in the FIG. 3B). In other words, the processing circuit 110 controls the UE 100 to switch from the low-power mode to the low-latency mode.

The low-power condition is that the first condition, the second condition, and the third condition are satisfied. If any one of the first condition, the second condition, and the third condition isn't satisfied, the low-power condition is not satisfied. The first condition is that a cDRX cycle of the UE 100 is a predefined value. For example, the predefined value is 40 ms. The second condition is that the reference signal received power (RSRP) measured at the UE 100 is higher than the RSRP threshold and the signal-to-noise ratio (SNR) measured at the UE 100 is higher than the SNR threshold. For example, the RSRP threshold is −90 dBm, and the SNR threshold is 25 dB. Switching to the low-power mode only when the second condition is satisfied can avoid the long latency caused by the bad channel condition. The third condition is that the fourth condition, the fifth condition, and the sixth condition are satisfied. If any one of the fourth condition, the fifth condition, and the sixth condition isn't satisfied, the third condition is not satisfied, and the low-power condition is not satisfied.

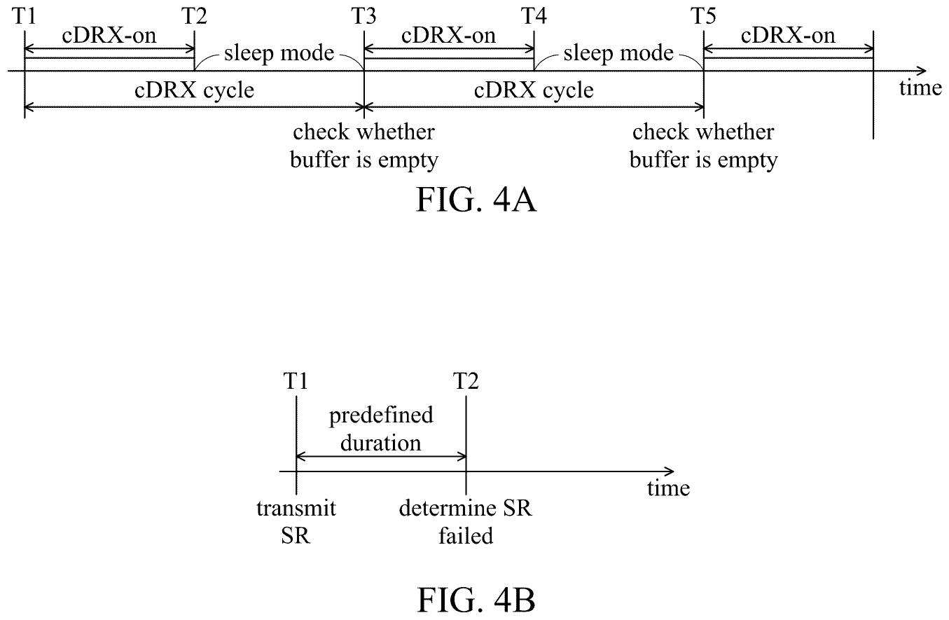

The fourth condition is that all the data transmitted from the application 111 to the modem 130 has been transmitted to the base station 200 in the previous cDRX cycle. In some embodiments, the modem 130 comprises a buffer. The buffer is configured to store the data transmitted from the application 111 to the modem 130, and the data in the buffer will be transmitted to the base station 200. The processing circuit 110 may determine whether the buffer is empty at the beginning of each cDRX-on cycle, so as to determine whether all the data transmitted from the application 111 to the modem 130 has been transmitted to the base station 200 in the previous cDRX cycle. When the buffer is empty at the beginning of the cDRX-on cycle, the processing circuit 110 determines that the fourth condition is satisfied. Otherwise, the processing circuit 110 determines that the fourth condition isn't satisfied. Refer to FIG. 4A, at time point T1, the UE 100 wakes-up from the sleep mode of the cDRX. At time point T2, the UE 100 enters the sleep mode of the cDRX. At time point T3, the UE 100 wakes-up from the sleep mode of the cDRX. At time point T3, the processing circuit 110 determines whether the buffer is empty, so as to determine whether all the data transmitted from the application 111 to the modem 130 has been transmitted to the base station 200 in the previous cDRX cycle (i.e. time duration between time point T1 to time point T3). Similarly, at time point T4, the UE 100 enters the sleep mode of the cDRX. At time point T5, the UE 100 wakes-up from the sleep mode of the cDRX. At time point T5, the processing circuit 110 determines whether the buffer is empty, so as to determine whether all the data transmitted from the application 111 to the modem 130 has been transmitted to the base station 200 in the previous cDRX cycle (i.e. time duration between time point T3 to time point T5). In this disclosure, time point T1, time point T3, and time point T5 may be referred to the beginning of the cDRX-on cycle.

The fifth condition is that data transmitted from the UE 100 to the base station 200 on the PUSCH doesn't need to be retransmitted. As described above, the application 111 transmits data to the modem 130, and the modem 130 transmits the data received from the application 111 to the base station 200 on the PUSCH. The fifth condition is that the data, which is received from the application 111, transmitted from the modem 130 to the base station 200 on the PUSCH doesn't need to be retransmitted. In some embodiments, the processing circuit 110 determines that the fifth condition is satisfied, in response to a determination that a block error rate (BLER) of data transmitted (from the modem 130 to the base station 200) on the PUSCH is zero. In some embodiments, the processing circuit 110 determines that the fifth condition is satisfied, in response to a determination that the UE 100 hasn't received a negative acknowledge (NACK) from the base station 200. In some embodiments, the NACK indicates that the data transmitted from the UE 100 to the base station 200 on the PUSCH requires to be retransmitted.

The sixth condition is that no SR transmitted from the UE 100 to the base station 200 has failed. In some embodiments, the processing circuit 110 determines that an SR transmitted from the UE 100 to the base station 200 has failed, in response to a determination that the UE 100 hasn't received an uplink grant from the base station 200 after transmitting the SR for a predefined duration. Refer to FIG. 4B, at time point T1, the UE 100 transmits the SR to the base station 200. At time point T2 which is the predefined duration after the time point T1, if the UE 100 doesn't receive the UL grant from the base station 200, the processing circuit 110 determines that the SR transmitted at time point T1 has failed (i.e. the sixth condition isn't satisfied). In some embodiments, the time point T1 and time point T2 are neighboring SR occasions. The UE 100 is allowed to transmit SR at the SR occasion. The UE 100 can determine whether to transmit SR at the SR occasion.

Wireless communication method and UE are provided in the present disclosure. The wireless communication method allows the UE to switch to the low-power mode to save power, when the low-power condition is met. When the low-power condition isn't met, the wireless communication method allows the UE to switch to the low-latency mode to maintain the low latency. Thus, embodiments of the present disclosure can reduce the power consumption without substantially impacting the latency and improve the user experience.

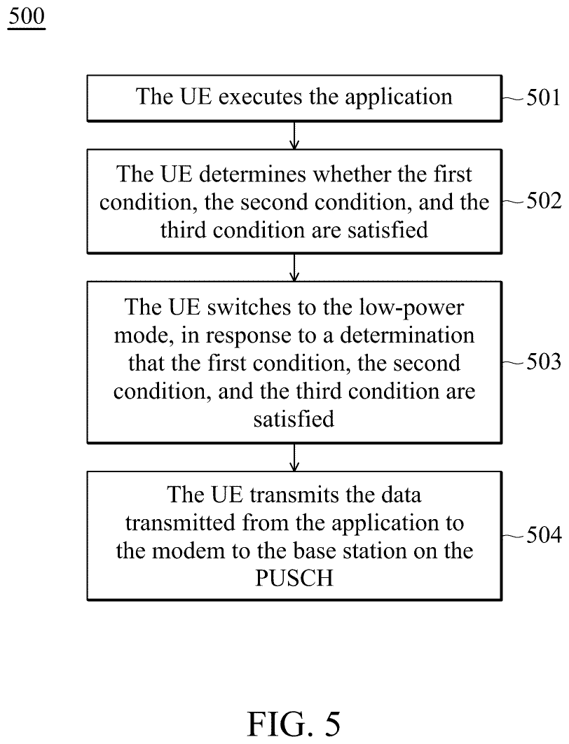

Refer to FIG. 5, FIG. 5 is a flow diagram of the wireless communication method 500 in accordance with the embodiments of the present disclosure. In operation 501, the processing circuit 110 of the UE 100 executes the application 111. In operation 502, the processing circuit 110 of the UE 100 determines whether the first condition, the second condition, and the third condition are satisfied. In operation 503, the UE 100 switches to the low-power mode (e.g. under the control of the processing circuit 110), in response to a determination that the first condition, the second condition, and the third condition are satisfied. In in the low-power mode, the application 111 transmits data to the modem 130 at the beginning of a cDRX-on cycle. In operation 504, the modem 130 of the UE 100 transmits the data transmitted from the application 111 to the modem 130 to the base station 200 on the PUSCH. The first condition is that a cDRX cycle of the UE 100 is a predefined value. The second condition is that a RSRP measured at the UE 100 is higher than the RSRP threshold and a SNR measured at the UE 100 is higher than the SNR threshold. The third condition is that a fourth condition, a fifth condition, and a sixth condition are satisfied. The fourth condition is that all the data transmitted from the application 111 to the modem 130 has been transmitted to the base station 200 in a previous cDRX cycle. The fifth condition is that data transmitted from the UE 100 to the base station 200 on the PUSCH doesn't need to be retransmitted. The sixth condition is that no SR transmitted from the UE to the base station 200 has failed.

In some embodiments, the UE 100 switches to the low-latency mode, in response to a determination that any one of the first condition, the second condition, and the third condition isn't satisfied. The application 111 transmits data to the modem 130 at a first time point which is a predefined duration before a second time point that the UE 100 transmits an SR, in the low-latency mode. The application generates the data at a third time point. The second time point is a time point nearest to the third time point and after the third time point

In some embodiments, the UE 100 stays in the low-latency mode in response to a determination that any one of the first condition, the second condition, and the third condition isn't satisfied. In some embodiments, the UE 100 switches to the low-power mode, in response to a determination that the first condition, the second condition, and the third condition have been satisfied for a predefined duration. In some embodiments, the UE 100 stays in the low-power mode in response to a determination that the first condition, the second condition, and the third condition are satisfied. In some embodiments, the processing circuit 110 of the UE 100 is configured to determine whether a buffer is empty, at the beginning of the cDRX on cycle, so as to determine whether the fourth condition is satisfied. The buffer is configured to store the data transmitted from the application 111 to the modem 130. The modem 130 comprises the buffer.

In some embodiments, the processing circuit 110 of the UE 100 is configured to determine that the fifth condition is satisfied, in response to a determination that: a BLER of data transmitted on the PUSCH is zero; or the UE 100 hasn't received a NACK from the base station 200. In some embodiments, the processing circuit 110 of the UE 100 is configured to determine that an SR transmitted from the UE 100 to the base station 200 has failed, in response to a determination that the UE 100 hasn't received an uplink grant from the base station 200 after transmitting the SR for a predefined duration. In some embodiments, the data transmitted from the application 111 to the modem 130 is voice data.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless communication method, comprising:
executing, via a user equipment (UE), an application;
determining, via the UE, whether a first condition, a second condition, and a third condition are satisfied; and
switching, via the UE, to a low-power mode, in response to a determination that the first condition, the second condition, and the third condition are satisfied, wherein the application transmits data to a modulator-demodulator (modem) of the UE at the beginning of a connected mode discontinuous reception (cDRX)-on cycle in the low-power mode;
transmitting, via the UE, the data transmitted from the application to the modem to a base station on a physical uplink shared channel (PUSCH);
wherein the first condition is that a cDRX cycle of the UE is a predefined value;
wherein the second condition is that a reference signal received power (RSRP) measured at the UE is higher than a RSRP threshold and a signal-to-noise ratio (SNR) measured at the UE is higher than an SNR threshold;
wherein the third condition is that a fourth condition, a fifth condition, and a sixth condition are satisfied;
wherein the fourth condition is that all data transmitted from the application to the modem has been transmitted to the base station in a previous cDRX cycle;
wherein the fifth condition is that data transmitted from the UE to the base station on the PUSCH doesn't need to be retransmitted;
wherein the sixth condition is that no scheduling request (SR) transmitted from the UE to the base station has failed.

2. The method as claimed in claim 1, further comprising:
switching, via the UE, to a low-latency mode, in response to a determination that any one of the first condition, the second condition, and the third condition isn't satisfied;
wherein the application transmits data to the modem at a first time point which is a predefined duration before a second time point that the UE transmits an SR, in the low-latency mode;
wherein the application generates the data at a third time point;
wherein the second time point is a time point nearest to the third time point and after the third time point.

3. The method as claimed in claim 2, further comprising:
staying in the low-latency mode in response to a determination that any one of the first condition, the second condition, and the third condition isn't satisfied.

4. The method as claimed in claim 1, wherein the UE switches to the low-power mode, in response to a determination that the first condition, the second condition, and the third condition have been satisfied for a predefined duration.

5. The method as claimed in claim 1, further comprising:
staying in the low-power mode in response to a determination that the first condition, the second condition, and the third condition are satisfied.

6. The method as claimed in claim 1, further comprising:
determining, via the UE, whether a buffer is empty, at the beginning of the cDRX on cycle, so as to determine whether the fourth condition is satisfied;
wherein the buffer is configured to store the data transmitted from the application to the modem.

7. The method as claimed in claim 1, further comprising:
determining, via the UE, that the fifth condition is satisfied, in response to a determination that:
a block error rate (BLER) of data transmitted on the PUSCH is zero; or
the UE hasn't received a negative acknowledge (NACK) from the base station.

8. The method as claimed in claim 1, further comprising:
determining, via the UE, that an SR transmitted from the UE to the base station has failed, in response to a determination that the UE hasn't received an uplink grant from the base station after transmitting the SR for a predefined duration.

9. The method as claimed in claim 1, wherein the data transmitted from the application to the modem is voice data.

10. A user equipment (UE), comprising:
a processing circuit, configured to execute an application; and
a modulator-demodulator (modem);
wherein the processing circuit is configured to:
determine whether a first condition, a second condition, and a third condition are satisfied; and
control the UE to switch to a low-power mode, in response to a determination that the first condition, the second condition, and the third condition are satisfied, wherein the application transmits data to the modem of the UE at the beginning of a connected mode discontinuous reception (cDRX)-on cycle in the low-power mode;
wherein the modem is configured to transmit the data transmitted from the application to the modem to a base station on a physical uplink shared channel (PUSCH);
wherein the first condition is that a cDRX cycle of the UE is a predefined value;
wherein the second condition is that a reference signal received power (RSRP) measured at the UE is higher than a RSRP threshold and a signal-to-noise ratio (SNR) measured at the UE is higher than a SNR threshold;
wherein the third condition is that a fourth condition, a fifth condition, and a sixth condition are satisfied;
wherein the fourth condition is that all the data transmitted from the application to the modem has been transmitted to the base station in a previous cDRX cycle;
wherein the fifth condition is that data transmitted from the UE to the base station on the PUSCH doesn't need to be retransmitted;
wherein the sixth condition is that no scheduling request (SR) transmitted from the UE to the base station has failed.

11. The UE as claimed in claim 10, wherein the processing circuit is further configured to:
control the UE to switch to a low-latency mode, in response to a determination that any one of the first condition, the second condition, and the third condition isn't satisfied;
wherein the application transmits data to the modem at a first time point which is a predefined duration before a second time point that the UE transmits an SR, in the low-latency mode;
wherein the application generates the data at a third time point;
wherein the second time point is a time point nearest to the third time point and after the third time point.

12. The UE as claimed in claim 11, wherein the processing circuit is further configured to:
control the UE to stay in the low-latency mode in response to a determination that any one of the first condition, the second condition, and the third condition isn't satisfied.

13. The UE as claimed in claim 10, wherein the processing circuit is further configured to control the UE to switch to the low-power mode, in response to a determination that the first condition, the second condition, and the third condition have been satisfied for a predefined duration.

14. The UE as claimed in claim 10, wherein the processing circuit is further configured to:
control the UE to stay in the low-power mode in response to a determination that the first condition, the second condition, and the third condition are satisfied.

15. The UE as claimed in claim 10, wherein the modem comprises a buffer configured to store the data transmitted from the application to the modem;
wherein the processing circuit is further configured to determine whether the buffer is empty, at the beginning of the cDRX on cycle, so as to determine whether the fourth condition is satisfied.

16. The UE as claimed in claim 10, wherein the processing circuit is further configured to:
determine that the fifth condition is satisfied, in response to a determination that:
a block error rate (BLER) of data transmitted on the PUSCH is zero; or
the UE hasn't received a negative acknowledge (NACK) from the base station.

17. The UE as claimed in claim 10, wherein the processing circuit is further configured to:
determine that an SR transmitted from the UE to the base station has failed, in response to a determination that the UE hasn't received an uplink grant from the base station after transmitting the SR for a predefined duration.

18. The UE as claimed in claim 10, wherein the data transmitted from the application to the modem is voice data.
